(19) United States
(12) Patent Application Publication
(10) Pub. No.: US 2018/0097885 A1
(43) Pub. Date: Apr. 5, 2018

(54) SMART ELECTRONIC APPARATUS

(71) Applicant: XIAMEN ECO LIGHTING CO. LTD., Xiamen (CN)

(72) Inventors: Danqing Liu, Xiamen (CN); Chenzhen Fu, Xiamen (CN); Xiaocong Zhang, Xiamen (CN)

(21) Appl. No.: 15/435,272

(22) Filed: Feb. 16, 2017

(30) Foreign Application Priority Data
Sep. 30, 2016 (CN) 201610867658.1

(51) Int. Cl. H04L 29/08; H04L 29/06

(52) U.S. Cl. CPC H04L 67/12; H04L 67/22; H04L 65/102; H04L 67/18

(57) ABSTRACT

A smart identifying apparatus is portable and a user can carry the smart identifying apparatus to different regions. The smart identifying apparatus includes a motion detecting circuit, a communicating circuit and a processing circuit. The motion detecting circuit detects motions for a user. The communicating circuit has an effective wireless communication distance, configured to communicate with an IOT gateway via a wireless communication protocol. The processing circuit compares the user motion detected by the motion detecting circuit with a predetermined motion rule, and decides if the communication circuit is controlled to actively generate a notice to communicate with the IOT gateway according to the comparing result.

### TECHNICAL FIELD

The present invention relates to a smart electronic apparatus, and more particularly relates to a portable smart electronic apparatus.

### BACKGROUND

Various kinds of electronic apparatuses are developed along with technological developments to improve people's life. In these technologies, one of them is an electronic apparatus which can provide a mechanism for smartly determining the user's location. It is very important for designers of such technologies to know if a user appears in some particular regions or which users appear in some particular regions. For example, if it is detected that a user appears inside a house or in an office space, a control apparatus can be designed to turn on a suitable light and other electronic apparatuses. On the other hand, if a user is detected that he leaves a house, or leaves the office space, a corresponding control apparatus can be designed to turn off the light, or to activate a security system

For designs in this filed, the battery capacity is always a bottleneck. An apparatus which needs frequent charging may reduce a user's willingness to use, or may cause inconvenience in operation. It would be very helpful if a portable electronic apparatus capable of determining a user's location and interacting with other devices can be developed.

### SUMMARY OF INVENTION

One embodiment of the present application provides a portable smart identifying apparatus. A user can carry the portable smart identifying apparatus to different regions and acts. A snap flip can be provided to this portable smart identifying apparatus, such that the portable smart identifying apparatus can be fastened to a key ring. Such portable smart identifying apparatus can be implemented in a mobile phone protecting shell, thereby a user can carry the portable smart identifying apparatus while carrying the mobile phone. The portable smart identifying apparatus can be provided to different kinds of daily necessaries, for example, a stuff that is convenient for a user to carry on, such as a wallet.

The portable smart identifying apparatus can comprise a circuit board on which a corresponding control chip, a detecting circuit and a corresponding communicating device, such as an antenna, are provided. Also, the portable smart identifying apparatus can comprise a lithium battery, a button cell battery, a normal battery or sharing a power source with other apparatuses. For example, such portable smart identifying apparatus can electrically connect to a battery of the mobile phone and acquire the power from the mobile phone battery.

The portable smart identifying apparatus can be implemented in a vehicle such as a car, a motor cycle, a bicycle, or a skateboard. The vehicles often leave or enter a particular region along with the user. In this sense, the method for providing the smart identifying apparatus to a vehicle also belongs to a scope for a portable smart identifying apparatus that a user can carry. The portable smart identifying apparatus is convenient for a user to carry and operate in different regions.

In one embodiment, the smart identifying apparatus comprises a motion detecting circuit, a communicating circuit and a processing circuit. The motion detecting circuit can be implemented by a triaxial accelerometer or an axis accelerometer along with other circuits, or implemented by other detecting circuits. For example, the motion detecting circuit can be implemented by a vibration senor or corresponding circuits. Additionally, based on different design requirements, such as cost or sensitivity, other existing products that can detect motions can be used to implement the motion detecting circuit.

Besides, the motion detecting circuit can comprise a detecting device, or comprise a combination of a plurality of detecting devices. If the motion detecting circuit comprises a combination of a plurality of detecting devices, many motion detecting results can be combined to determine a motion of a user who carries this motion detecting circuit, to acquire a more accurate determining result. Besides, detecting devices with lower cost or lower power consumption can be used when cost is a major concern.

Additionally, the communicating circuit of the smart identifying apparatus has an effective wireless transmitting distance in connecting to the IOT gateway. The IOT gateway mentioned here means an IOT gateway for IOT application, which can be applied to control other IOT apparatuses to perform a predetermined operation. It is noted that, with continuously improving techniques and lower cost, today's IOT apparatuses can provide not only specific applications, such as light, music playing, or temperature adjusting, but also above-mentioned IOT gateway functions. In other words, an LED provided in a ceiling can comprise a circuit board with a corresponding communicating circuit, such that the desired IOT gateway function can be achieved. In another example, a necessary communicating circuit can be implemented in a television to provide the desired IOT gateway function. Or, in still another example, an independent machine is set up to provide the desired IOT gateway function.

The IOT gateway can follow one of various communicating protocols, for example, Z-Wave, Zigbee, or other published standards, or other communicating standards defined by some specific manufacturers. Such IOT gateway can be a single electronic apparatus, such as an air conditioner, and does not control other electronic equipment's.

Specifically, the effective wireless transmitting distance for the communicating circuit can indicate a current location of the user via setting the power and related parameters for the communicating circuit. The communicating circuit communicates with an IOT gateway via a wireless communication protocol in the effective wireless communication distance, such that the IOT gateway can determine if the communication circuit is in the effective wireless communication distance corresponding to the IOT gateway.

The IOT apparatus is informed to perform a corresponding operation based on a predetermined rule if the IOT gateway determines that the communication circuit is in the effective wireless communication distance corresponding to the IOT gateway. For example, if the effective wireless communication distance is 5 m, it is suitable for a room design. If the user carries the smart identifying apparatus, enters a room having an IOT gateway, and the smart identifying apparatus successfully communicates with the IOT gateway, the IOT gateway can determine that the user appears in the 5 m range and turns on corresponding IOT equipment, such as air conditioners or lights. To the contrary, if the smart identifying apparatus cannot successfully connect with the IOT gateway, the IOT gateway turns off the light, the air conditioner or related equipment according to a predetermined rule. Another scenario is that, when the smart identifying apparatus successfully connects to the IOT gateway, the IOT gateway can turn on, turn off or adjust IOT apparatuses, to match the requirements for different users in the same region. For example, if the user A and B appear in the same room concurrently, and the IOT gateway connects to two corresponding smart identifying apparatus, the IOT gateway can adjust the air conditioner to provide the environment suitable for two people, or playing corresponding music.

The processing circuit of the smart identifying apparatus compares the user motion detected by the motion detecting circuit with a predetermined motion rule, and decides if the communication circuit is controlled to actively generate a notice to attempt to communicate with the IOT gateway according to the comparing result. In other words, the motion detecting circuit detects if the user has a motion, or detects what the motion is. The motion results for the detected motions are transmitted to the processing circuit after processed or without processed. The processing circuit determines if the detected motion meets a predetermined motion mode according to a predetermined motion rule. If the detected motion meets a predetermined motion mode, the communicating circuit attempts to communicate with the IOT gateway. If the communication is successfully established, the IOT gateway determines the user probably appears in this region and corresponding operation is performed, to control a corresponding electronic equipment to perform a predetermined motion.

With this mechanism, the communicating circuit does not need to continuously communicate with the IOT gateway. The user may work outside in day time, therefore the necessary time that the communication of the IOT gate for the house should be attempted to be established only occupies a small part of all time. On the other hand, if a user would like to move from one region to another region, he often has some motions. That is, the determining operation for determining if any user enters a communicating range of an IOT gateway is only needed while the user has some specific motions. Via the cooperation for the processing circuit and the motion detecting circuit, unnecessary communication attempting can be greatly reduced, thus the power consumption can be decreased.

As above-mentioned descriptions, the smart identifying apparatus is expected to be light and handy. The advantage of the identifying apparatus is great if the battery power can keep the electronic apparatus active for months.

In another embodiment, the processing circuit controls the communication circuit not to communicate with the IOT gateway if the processing circuit estimates the user has no motion matching the predetermined motion rule according to the comparing result. That is, the communicating circuit need not waste power to attempt unnecessary communication if no motion is detected.

In some embodiments, the processing circuit activates the communication circuit to attempt to communicate with the IOT gateway if the processing circuit estimates the user has at least one motion matching the predetermined motion rule according to the comparing result, to confirm if the communication circuit is in the effective wireless communication distance corresponding to the IOT gateway.

The predetermined motion rule can be adjusted according to different requirements. For example, the motion detecting circuit and the processing circuit can use statistical data of motions of a user to find out more detailed motions, and further define most possible motions of the user to precisely detect a corresponding motion and accordingly determines if a user enters a specific region. On the other hand, in order to reduce cost and design complexity, the motion detecting circuit can just determine if any motion happens, and the processing circuit informs the communicating circuit to attempt to communicate with the IOT gateway if any motion is detected, to determine if the user enters a specific region.

A single smart identifying apparatus can be used with different IOT gateways in different regions. For example, a first IOT gateway is provided in the house and a second IOT gateway is provided in the office. In some embodiments, a single IOT gateway can correspond to a plurality of smart identifying apparatuses. Comparing with a conventional method that uses infrared light or ultrasonic wave to detect is any user appears in a specific space, the smart identifying apparatus can further set the user's identifying code, and the rule for the user can be set as well. Using the settings, various convenient services can be applied to a user. Moreover, such design can be continuously updated adapting to different environments, for example, via learning algorithms and mechanisms by various kinds machines, to find a best mode for smart services.

In another embodiment, the IOT gateway informs the IOT apparatus to activate a security operation if the IOT gateway notices the communicating circuit moves from a location in the effective wireless communication distance corresponding to the IOT gateway to a location out of the effective wireless communication distance corresponding to the IOT gateway. In other words, if the user carries the smart identifying apparatus and leaves the house or the offices, that is, the IOT gateway cannot continuously communicate with the smart identifying apparatus that the user carries, the IOT gateway can automatically activate a corresponding security operation, for example, activate the security equipment in the house. That is, if the user leaves the house but some dangers occur, such as forgetting to turn off the gas or a thief invades, the IOT gateway can perform corresponding operations according to a predetermined rule.

The abovementioned motion detecting circuit, the processing circuit and the communicating circuit can be implemented in the same case or housing. In another example, the motion detecting circuit, the smart identifying apparatus, the processing circuit and the communicating apparatus can be implemented into different apparatuses. For example, the motion detecting circuit is provided in a bracelet that can communicate with a processing circuit of the smart identifying apparatus via wireless communication and transmit detected user motion. After that, the processing circuit of the smart identifying apparatus performs above-mentioned corresponding processes according to a predetermined motion rule.

To save more power, the communicating circuit enters a power saving mode if the communicating circuit does not attempt to communicate with the IOT gateway. Various kinds of conventional power saving or sleeping design can be applied to implement the power saving mode. For example, the circuit can be designed to have different power supplies for different modules, and the processing circuit controls a corresponding power supplying module to awake or to inform the communicating circuit to enter a power saving mode. Based on current electronic techniques, only little power or even zero power are needed if the module enters a power saving mode. Therefore, the power for the smart identifying apparatus can be significantly reduced, such that limited battery power can sustain for a longer time.

For determining the motion mode more accurately, in one embodiment, the processing circuit has a proofing mode. The processing circuit controls the communicating circuit to continuously attempt to communicate with the IOT gateway in the proofing mode, no matter what user motion is detected. In other words, the processing circuit can record the motion of a user and whether the IOT gateway is successfully connected. Such comparing can be a basement for adjusting or setting the above-mentioned motion rule. For example, classifying the detected motions to different kinds, and counting a number that the communicating circuit successfully connects to the IOT gateway for different kinds of detected motions. By this way, some motion modes that need no attempting for connecting the IOT gateway can be excluded and the power can be further saved.

In another embodiment, the processing circuit can adjust the predetermined motion rules according to communicating results that the communicating circuit attempts to communicate with the IOT gateway when the predetermined motion rule is matched. In other words, the processing circuit can collects statistical data to find out a percentage that the communicating circuit fails to connect to the IOT gateway according to the currently used motion rule. Also, the motion rule can be adjusted according to the percentage that the communicating circuit successfully connect to the IOT gateway.

The IOT gateway can perform a corresponding operation after determining that the user enters a specific region. The smart identifying apparatus itself can activate the corresponding operations according to whether the smart identifying apparatus is continuously connected to the IOT gateway. For example, the smart identifying apparatus can comprise other circuits or apparatuses, which can perform different operations based on a command of the processing circuit if the user enters a predetermined region or leaves a predetermined region.

Besides, in order to handle abnormal situations, the identifying apparatus can have an electronic or mechanic switch, for a user to activate or to stop an operation that the communicating circuit is controlled to attempt to communicate with the IOT gateway according to an motion detected by the motion detecting circuit.

In one embodiment, the processing circuit can comprise a security mode. In such case, the smart identifying apparatus is provided in an object to be protected. If the processing circuit is in the security mode and the motion sensing circuit detects the motion, the communicating circuit informs the IOT gateway to activate a corresponding security operation. For example, the smart identifying apparatus can be hanged on the doorknob, and the motion detecting circuit of the smart identifying apparatus is triggered if someone turns the doorknob. In such case, the smart identifying apparatus generates alarm, or the IOT gateway is informed to perform corresponding operations. It is noted that the “security mode” mentioned here does not mean that the smart identifying apparatus must appear in the above-mentioned transmitting range of the IOT gateway. Therefore, for example, such smart identifying apparatus can be a small buckle such that the user can hang it on the doorknob of the hotel while user has a business trip. Alternatively, the user can hang it to the luggage on the luggage rack. In other words, the same smart identifying apparatus not only can save power but also can provide different applications.

Additionally, for stability and reliability, in another embodiment, even if no motion is detected, the processing circuit can control the communicating circuit to periodically attempt to communicate with the IOT gateway after no motion is detected. For example, the processing circuit still informs the communicating circuit to attempt to connect to the IOT gateway every 2 minutes even if no motion is detected. Additionally, the processing circuit even can classify the motion mode, and sets the time period that the communicating circuit attempts to connect to the IOT gateway for different motion modes.

Additionally, in one embodiment, the smart identifying apparatus can comprise a time circuit. In other words, the smart identifying apparatus can know it is morning or evening. The processing circuit can apply different motion rules according to the current time that the time circuit provides. For example, different motion rules can be respectively used to midnight, daytime, or transportation time. By this way, the power can be reduced more efficiently, and the issues for wrong determining or non-determining can be avoided.

If time information is also considered, in another embodiment, the processing circuit can count a number that the communicating circuit successfully connects to the IOT gateway for different timings to adjust the motion rule. By this way, the motion rule can be more precisely adjusted and set according to user behaviors for different users.

Besides, in another embodiment, the smart identifying apparatus can further comprise an additional communicating circuit. The additional communicating circuit identifies a location for the smart identifying apparatus via an additional communicating protocol. The control circuit attempts to communicate with the IOT gateway via the additional communicating circuit. For example, the additional communicating circuit can use Bluetooth, Wi-Fi or NFC. Further, the smart identifying apparatus can comprise another communicating circuit besides the communicating circuit applying Z-wave. If an electronic equipment which can be connected is found in a specific region via the additional communicating circuit such as a Bluetooth apparatus, it is helpful for determining that the smart identifying apparatus already appears in a corresponding region. Via this method, the accuracy and reliability for connection of the IOT gateway can be further increased.

In another embodiment, the smart identifying apparatus can comprise a battery circuit. The processing circuit refers to the remaining battery power to set a rule that the communicating circuit attempt to communicate with the IOT gateway if the battery circuit determines the battery power is lower than a predetermined value. In other words, the processing circuit for the smart identifying apparatus can have different processing rules for different battery powers.

In view of above-mentioned different embodiments, a more convenient IOT gateway design can be provided to a user.

### BRIEF DESCRIPTION OF DRAWINGS

FIG. 1 is a schematic diagram illustrating an application for a smart identifying apparatus according to one embodiment of the present invention.

FIG. 2 is a block diagram illustrating a smart identifying apparatus according to one embodiment of the present invention.

FIG. 3 is a flow chart illustrating the determining rules for the smart identifying apparatus according to one embodiment of the present invention.

FIG. 4 is a block diagram illustrating a smart identifying apparatus according to another embodiment of the present invention.

FIG. 5 is a schematic diagram illustrating the interactions between the smart identifying apparatus and an IOT (interest of things) gateway.

FIG. 6 is a schematic diagram illustrating the application that the smart identifying apparatus is applied as a security apparatus.

### DETAILED DESCRIPTION

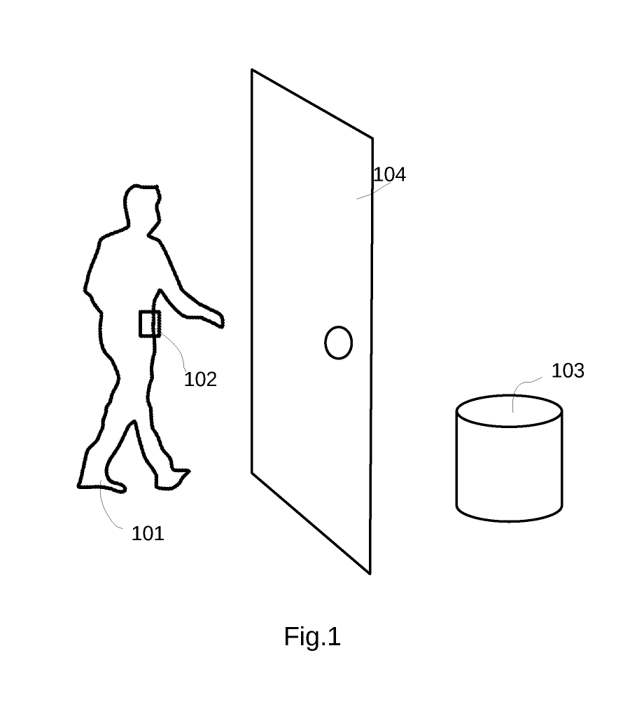

Please refer to FIG. 1, which is a schematic diagram illustrating an application for a smart identifying apparatus according to one embodiment of the present invention. As shown in FIG. 1, the user 101 carries the smart identifying apparatus 102. The user can enter the space after the door 104 and acts, and can leave as well. In this space, an IOT gateway 103 having an effective transmitting range is provided. The IOT gateway 103 has an effective transmission range. In other words, when the user is in a space outside the door 104, the smart identifying apparatus 102 may not communicate with the IOT gateway 103 for being out of the transmitting range. With such characteristics, deciding whether the user 101 is in the predetermined space can be based on whether the smart identifying apparatus 102 successfully communicates with the IOT gateway 103.

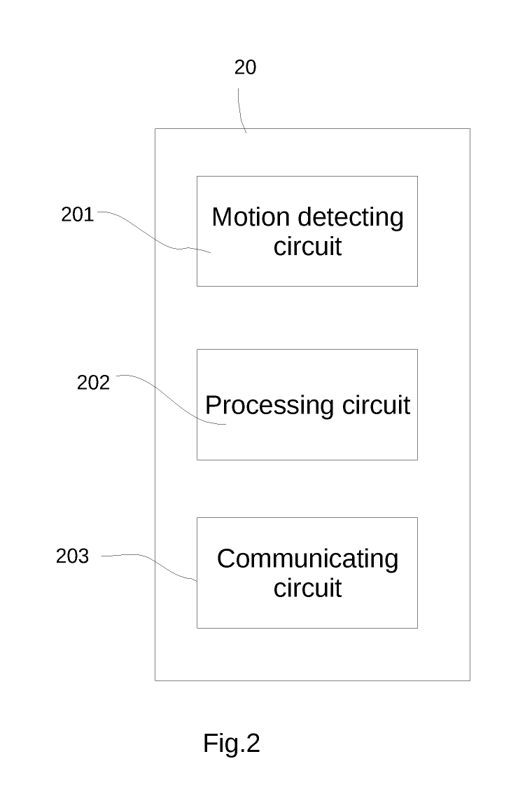

Please refer to FIG. 2, which is a block diagram illustrating a smart identifying apparatus according to one embodiment of the present invention.

A user can carry the portable smart identifying apparatus 20 to different regions and, a snap flip can be provided along with this portable smart identifying apparatus, such that the portable smart identifying apparatus can be fastened to a key ring. In another embodiments, the portable smart identifying apparatus can be implemented in a mobile phone protecting shell, thereby a user can carry the portable smart identifying apparatus along with the mobile phone. Additionally, the portable smart identifying apparatus 20 can be embedded into different kinds of daily necessaries, for example, a gadget that is convenient for a user to carry on, such as a wallet.

Such portable smart identifying apparatus 20 can comprise a circuit board on which a corresponding control chip, a detecting circuit and a corresponding communicating device, such as an antenna, are provided. Also, the portable smart identifying apparatus can comprise a lithium battery, a button cell battery, a normal battery or share a power source with other apparatuses. For example, such portable smart identifying apparatus can electrically connect to a battery of the mobile phone and acquire the power from the mobile phone battery. The portable smart identifying apparatus 20 can be implemented in a vehicle such as a car, a motor cycle, a bicycle, or a skateboard. Such vehicles often leave or enter a particular region along with the user. In this sense, smart identifying apparatuses embedded in vehicles are within the definition of a portable smart identifying apparatus. Such portable smart identifying apparatus is convenient for a user to carry and operate in different regions.

In one embodiment, the smart identifying apparatus 20 comprises a motion detecting circuit 201, a communicating circuit 203 and a processing circuit 202. The motion detecting circuit 201 can be implemented by a triaxial accelerometer or a nine-axis accelerometer along with other circuits, or implemented by other detecting circuits. For example, the motion detecting circuit 201 can be implemented by a vibration senor or corresponding circuits. Additionally, based on different design requirements, such as cost or sensitivity, other existing products that can detect motions can be used to implement the motion detecting circuit 201.

Besides, the motion detecting circuit 201 can comprise a detecting device, or comprise a combination of a plurality of detecting devices. If the motion detecting circuit 201 comprises a combination of a plurality of detecting devices, many motion detecting results can be combined to determine an motion of a user who carries this motion detecting circuit, to acquire a more accurate determining result. Besides, detecting devices with lower cost or lower power consumption can be used when cost is a major concern.

Additionally, the communicating circuit 203 of the smart identifying apparatus has an effective wireless transmitting distance in connecting to the IOT gateway. The IOT gateway mentioned here means an IOT gateway for IOT application which can control other IOT apparatuses to perform a predetermined operation. It is noted that, with continuously improving techniques and lower cost, today's IOT apparatuses can provide not only specific applications, such as light, music playing, or temperature adjusting, but also above-mentioned IOT gateway functions. In other words, an LED provided in a ceiling can comprise a circuit board with a corresponding communicating circuit, such that the desired IOT gateway function can be achieved. In another example, a necessary communicating circuit can be implemented in a television to provide the desired IOT gateway function. Or, in still another example, an independent machine is set up to provide the desired IOT gateway function.

The IOT gateway can follow one of various communicating protocols, for example, Z-Wave, Zigbee, or other published standards, or other communicating standards defined by some specific manufacturers. Such IOT gateway can be a single electronic apparatus, such as an air conditioner, and does not control other electronic equipment's.

Specifically, the effective wireless transmitting distance for the communicating circuit 203 can indicate a current location of the user via setting the power and related parameters for the communicating circuit 203. The communicating circuit 203 communicates with an IOT gateway via a wireless communication protocol in the effective wireless communication distance, such that the IOT gateway can determine if the communication circuit is in the effective wireless communication distance corresponding to the IOT gateway.

The IOT apparatus is informed to perform a corresponding operation based on a predetermined rule if the IOT gateway determines that the communication circuit is in the effective wireless communication distance corresponding to the IOT gateway. For example, if the effective wireless communication distance is 5 m, it is suitable for a room design. If the user carries the smart identifying apparatus 20, enters a room having an IOT gateway, and the smart identifying apparatus 20 successfully communicate with the IOT gateway, the IOT gateway can determine that the user appears in the 5 m range and turns on a corresponding IOT equipment, such as air conditioners or lights. To the contrary, if the smart identifying apparatus 20 cannot successfully connect with the IOT gateway, the IOT gateway turns off the light, the air conditioner or related equipment according to a predetermined rule. Another scenario is that, when the smart identifying apparatus 20 successfully connects to the IOT gateway, the IOT gateway can turn on, turn off or adjust IOT apparatuses, to match the requirements for different users in the same region. For example, if the user A and B appear in the same room concurrently, and the IOT gateway connects to two corresponding smart identifying apparatus 20, the IOT gateway can adjust the air conditioner to provide the environment suitable for two people, or playing corresponding music.

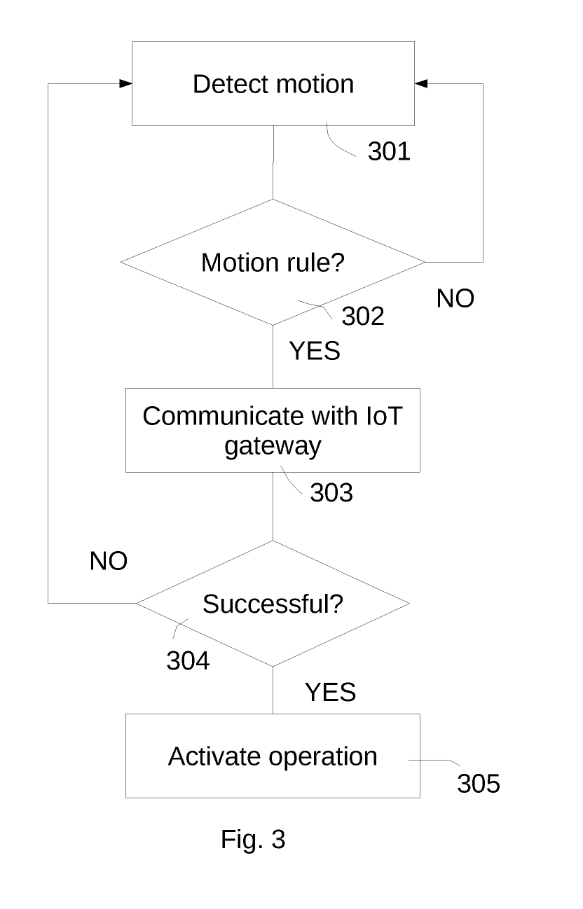

Please refer to FIG. 3, which is a flow chart illustrating the determining rules for the smart identifying apparatus according to one embodiment of the present invention.

The processing circuit 202 of the smart identifying apparatus 20 compares the user motion detected by the motion detecting circuit (step 301) with a predetermined motion rule (step 302), and decides whether to let the communication circuit 203 actively generate a signal to attempt to communicate with the IOT gateway according to the comparing result (step 303). The IOT gateway activates corresponding operations (step 305) if successfully connected (step 304). In other words, the motion detecting circuit 201 detects if the user has an motion, or detects what the motion is. The motion results for the detected motions, either being processed or not, are transmitted to the processing circuit 202. The processing circuit 202 determines if the detected motion meets a predetermined motion mode according to a predetermined motion rule. If the detected motion meets a predetermined motion mode, the communicating circuit 203 attempts to communicate with the IOT gateway. If the communication is successfully established, the IOT gateway determines the user probably appears in this region and corresponding operation is performed, to control a corresponding electronic equipment to perform a predetermined motion.

Via this mechanism, the communicating circuit 203 does not need to continuously communicate with the IOT gateway. The user may work outside in day time, therefore the necessary time that the communication of the IOT gate for the house should be attempted to be established only occupies a small part of all time. On the other hand, if a user moves from one region to another region, he often has some specific motions. That is, the determining operation for determining if any user enters a communicating range of an IOT gateway is only needed while the user has some specific motions. Via the cooperation for the processing circuit 202 and the motion detecting circuit 201, unnecessary communication attempting can be greatly reduced, thus the power consumption can be decreased.

As above-mentioned descriptions, the smart identifying apparatus 20 is expected to be light and handy. The advantage of the identifying apparatus is great if the battery power can keep the electronic apparatus active for months.

In another embodiment, the processing circuit 202 controls the communication circuit 203 not to communicate with the IOT gateway if the processing circuit 202 estimates the user has no motion matching the predetermined motion rule according to the comparing result. That is, the communicating circuit 203 need not waste power to attempt unnecessary communication if no motion is detected.

In some embodiments, the processing circuit 202 activates the communication circuit 203 to attempt to communicate with the IOT gateway if the processing circuit 202 estimates the user has at least one motion matching the predetermined motion rule according to the comparing result, to confirm if the communication circuit 203 is in the effective wireless communication distance corresponding to the IOT gateway.

The predetermined motion rule can be adjusted according to different requirements. For example, the motion detecting circuit 201 and the processing circuit 202 can use statistical data of motions of a user to find out more detailed motions, and further define most possible motions of the user to precisely detect determine if a user enters a specific region. On the other hand, in order to reduce cost and design complexity, the motion detecting circuit can just determine if any motion happens, and the processing circuit 202 informs the communicating circuit 203 to attempt to communicate with the IOT gateway if any motion is detected, to determine if the user enters a specific region.

A single smart identifying apparatus 20 can be used with different IOT gateways in different regions. For example, a first IOT gateway is provided in the house and a second IOT gateway is provided in the office. In some embodiments, a single IOT gateway can correspond to a plurality of smart identifying apparatuses 20. Comparing with a conventional method that uses infrared light or ultrasonic wave to detect if any user appears in a specific space, the smart identifying apparatus 20 can be further set the user's identifying code, and the rule for the user can be set as well. Using the settings, various convenient services can be applied to a user. Moreover, such design can be continuously updated adapting to different environments, for example, via learning algorithms and mechanisms by various kinds machines, to find a best mode for smart services.

In another embodiment, the IOT gateway informs the IOT apparatus to activate a security operation if the IOT gateway notices the communicating circuit 203 moves from a location in the effective wireless communication distance corresponding to the IOT gateway to a location out of the effective wireless communication distance corresponding to the IOT gateway. In other words, if the user carries the smart identifying apparatus 20 and leaves the house or the offices, that is, the IOT gateway cannot continuously communicate with the smart identifying apparatus 20 that the user carries, the IOT gateway can automatically activate a corresponding security operation, for example, activate the security equipment in the house. That is, if the user leaves the house but some dangers occur, such as forgetting to turn off the gas or a thief invades, the IOT gateway can perform corresponding operations according to a predetermined rule.

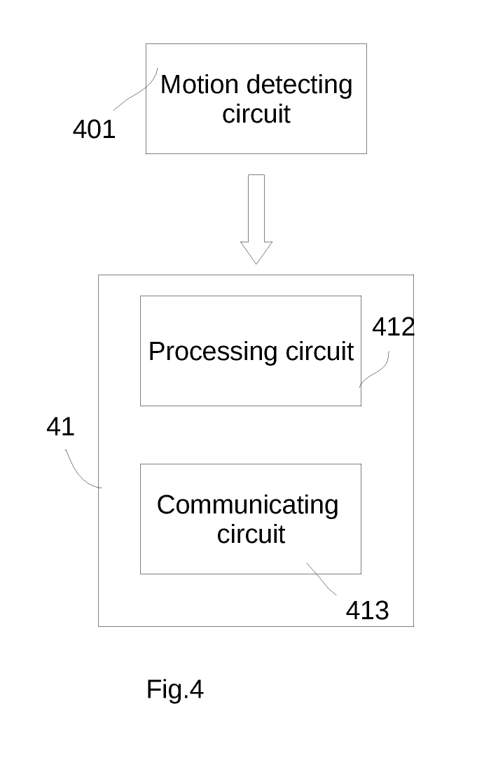

Please refer to FIG. 4, which is a block diagram illustrating a smart identifying apparatus according to another embodiment of the present invention. The abovementioned motion detecting circuit, the processing circuit and the communicating circuit can be implemented in the same case or housing. In another example, the motion detecting circuit 401, the smart identifying apparatus 41, the processing circuit 412 and the communicating apparatus 413 can be implemented into different apparatuses, as illustrated in FIG. 4. For example, the motion detecting circuit 401 is provided in a bracelet that can communicate with a processing circuit of the smart identifying apparatus via wireless communication and transmit detected user motion. After that, the processing circuit of the smart identifying apparatus performs above-mentioned corresponding processes according to a predetermined motion rule.

To save more power, the communicating circuit enters a power saving mode if the communicating circuit does not attempt to communicate with the IOT gateway. Various kinds of conventional power saving or sleeping design can be applied to implement the power saving mode. For example, the circuit can be designed to have different power supplies for different modules, and the processing circuit controls a corresponding power supplying module to awake or to inform the communicating circuit to enter a power saving mode. Based on current electronic techniques, only little power or even zero power are needed if the module enters a power saving mode. Therefore, the power for the smart identifying apparatus can be significantly reduced, such that limited battery power can sustain for a longer time.

For determining the motion mode more accurately, in one embodiment, the processing circuit has a proofing mode. The processing circuit controls the communicating circuit to continuously attempt to communicate with the IOT gateway in the proofing mode, no matter what user motion is detected. In other words, the processing circuit can record the motion of a user and whether the IOT gateway is successfully connected. Such comparing can be a base for adjusting or setting the above-mentioned motion rule. For example, classifying the detected motions to different kinds, and counting a number that the communicating circuit successfully connects to the IOT gateway for different kinds of detected motions. By this way, some motion modes that need no attempting for connecting the IOT gateway can be excluded and the power can be further saved.

In another embodiment, the processing circuit can adjust the predetermined motion rules according to communicating results that the communicating circuit attempts to communicate with the IOT gateway when the predetermined motion rule is matched. In other words, the processing circuit can collect statistical data to find out a percentage that the communicating circuit fails to connect to the IOT gateway according to the currently used motion rule. Also, the motion rule can be adjusted according to the percentage that the communicating circuit successfully connects to the IOT gateway.

The IOT gateway can perform a corresponding operation after determining that the user enters a specific region. The smart identifying apparatus itself can activate the corresponding operations according to whether the smart identifying apparatus is connected to the IOT gateway. For example, the smart identifying apparatus can comprise other circuits or apparatuses, which can perform different operations based on a command of the processing circuit if the user enters a predetermined region or leaves a predetermined region.

Besides, in order to handle abnormal situations, the identifying apparatus can have an electronic or mechanical switch, for a user to activate or to stop an operation that the communicating circuit is controlled to attempt to communicate with the IOT gateway according to an motion detected by the motion detecting circuit.

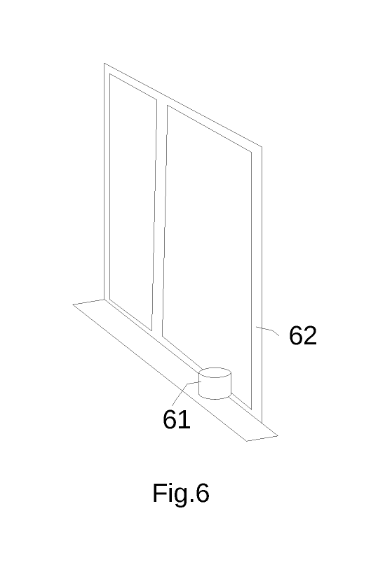

FIG. 6 is a schematic diagram illustrating the application that the smart identifying apparatus is applied as a security apparatus. In this embodiment, the processing circuit can comprise a security mode. In such case, the smart identifying apparatus 61 is implemented in an object to be protected 62, for example, a window or a door. If the processing circuit is in the security mode and the motion sensing circuit detects the motion, the communicating circuit informs the IOT gateway to activate a corresponding security operation. For example, the smart identifying apparatus 61 can be hanged on the doorknob, and the motion detecting circuit of the smart identifying apparatus 61 is triggered if someone turns the doorknob. In such case, the smart identifying apparatus 61 generates alarm, or the IOT gateway is informed to perform corresponding operations. It is noted that the “security mode” mentioned here does not mean that the smart identifying apparatus 61 must appear in the above-mentioned transmitting range of the IOT gateway. Therefore, for example, such smart identifying apparatus 61 can be a small buckle such that the user can hang it on the doorknob of the hotel while user has a business trip. Alternatively, the user can hang it to the luggage on the luggage rack. In other words, the same smart identifying apparatus 61 not only can save power but also can provide different applications.

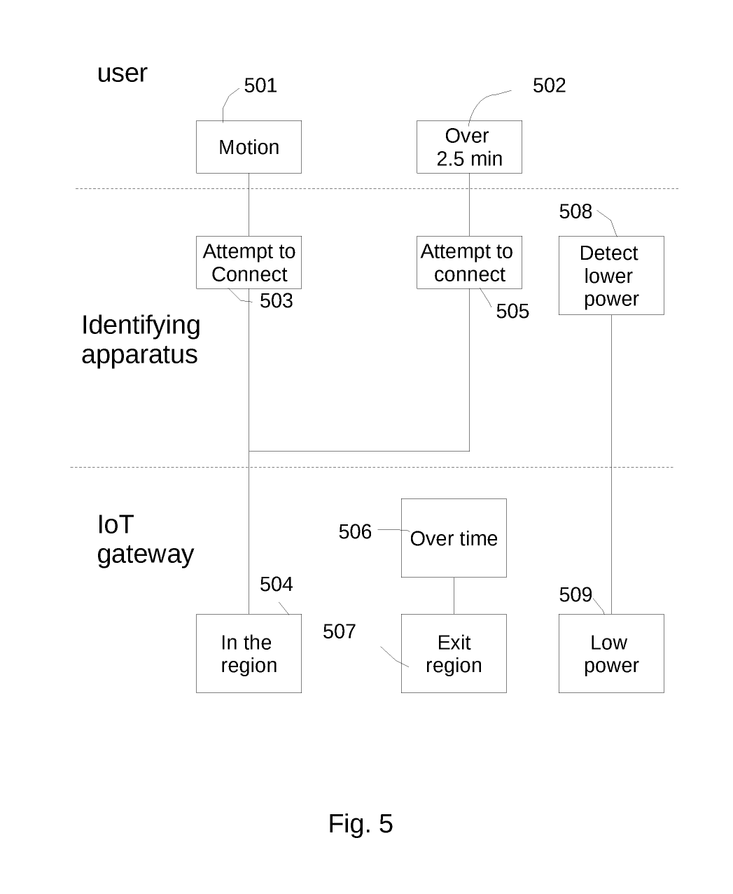

Please refer to FIG. 5, which is a schematic diagram illustrating an IOT gateway, a smart identifying apparatus and operations for a user. The smart identifying apparatus attempts to connect with the IOT gateway (step 503) while the user moves (step 501). The IOT gate determines the user is in the predetermined region if successfully connected (step 504). Additionally, for stability and reliability, even if no motion is detected, the processing circuit can control the communicating circuit to periodically attempt to communicate with the IOT gateway for a predetermined time (ex 2.5 minutes), according to the motion rule. For example, the processing circuit still informs the communicating circuit to attempt to connect to the IOT gateway every 2.5 minutes even if no motion is detected. Additionally, the processing circuit even can classify motion modes, and set the time period that the communicating circuit attempts to connect to the IOT gateway for different motion modes. Further, the IOT gateway determines the user leaves this region (step 507) and activates related operation (ex. turn off the light) if the smart identifying apparatus is not connected for a predetermined time period (step 506). Furthermore, in order to avoid wrong determining while the smart identifying apparatus has no power, the smart identifying apparatus can inform the IOT gateway to perform an operation corresponding to a low power situation (step 509) if the smart identifying apparatus detects a low power (step 508).

In one embodiment, the smart identifying apparatus can comprise a time circuit. In other words, the smart identifying apparatus can know it is morning or evening. The processing circuit can use different motion rules according to the current time that the time circuit provides. For example, different motion rules can be respectively used to midnight, daytime, or transportation time. By this way, the power can be reduced more efficiently, and the issues for wrong determining or non-determining can be avoided.

If time information is also considered, in another embodiment, the processing circuit can count a number that the communicating circuit successfully connects to the IOT gateway for different timings to adjust the motion rule. By this way, the motion rule can be more precisely adjusted and set according to user behaviors for different users.

Besides, in another embodiment, the smart identifying apparatus can further comprise an additional communicating circuit. The additional communicating circuit identifies a location for the smart identifying apparatus via an additional communicating protocol. The control circuit attempts to communicate with the IOT gateway via the additional communicating circuit. For example, the additional communicating circuit can use Bluetooth, Wi-Fi or NFC. Further, the smart identifying apparatus can comprise another communicating circuit besides the communicating circuit applying Z-wave. If an electronic equipment which can be connected is found in a specific region via the additional communicating circuit such as a Bluetooth apparatus, it is helpful for determining that the smart identifying apparatus already appears in a corresponding region. Via this method, the accuracy and reliability for connection of the IOT gateway can be further increased.

In another embodiment, the smart identifying apparatus can comprise a battery circuit. The processing circuit refers to the remaining battery power to set a rule that the communicating circuit attempt to communicate with the IOT gateway if the battery circuit determines the battery power is lower than a predetermined value. In other words, the processing circuit for the smart identifying apparatus can have different processing rules for different battery powers.

Those skilled in the art will readily observe that numerous modifications and alterations of the device and method may be made while retaining the teachings of the invention. Accordingly, the above disclosure should be construed as limited only by the metes and bounds of the appended claims.

1. A smart identifying apparatus portable for a user to carry among different regions, comprising:
a motion detecting circuit, configured to detect motions of a user;
a communicating circuit, having an effective wireless communication distance, configured to communicate with an IOT gateway via a wireless communication protocol in the effective wireless communication distance, such that the IOT gateway is capable of determining if the communication circuit is within the effective wireless communication distance corresponding to the IOT gateway, wherein an IOT apparatus is informed to perform a corresponding operation based on a predetermined rule if the IOT gateway determines that the communication circuit is in the effective wireless communication distance corresponding to the IOT gateway; and
a processing circuit, configured to compare the user motion detected by the motion detecting circuit with a predetermined motion rule, and configured to decide if the communication circuit is controlled to actively generate a signal to communicate with the IOT gateway according to the comparing result.

2. The smart identifying apparatus of claim 1, wherein the processing circuit controls the communication circuit not to communicate with the IOT gateway if the processing circuit determines that the user has no motion matching the predetermined motion rule according to the comparing result.

3. The smart identifying apparatus of claim 1, wherein the processing circuit activates the communication circuit to attempt to communicate with the IOT gateway if the processing circuit determines that the user has at least one motion matching the predetermined motion rule according to the comparing result, to confirm if the communication circuit is in the effective wireless communication distance corresponding to the IOT gateway.

4. The smart identifying apparatus of claim 1, wherein the IOT gateway informs the IOT apparatus to activate a security operation if the IOT gateway determines the communicating circuit moves from a location in the effective wireless communication distance corresponding to the IOT gateway to a location out of the effective wireless communication distance corresponding to the IOT gateway.

5. The smart identifying apparatus of claim 1, wherein the motion detecting circuit, the processing circuit and the communicating circuit are in a single case.

6. The smart identifying apparatus of claim 1, wherein the motion detector transmits at least one detected user motion to the processing circuit via a wireless communication, to control the communication circuit according to the predetermined motion rule.

7. The smart identifying apparatus of claim 1, wherein the communicating circuit enters a power saving mode if the communicating circuit does not attempt to communicate with the IOT gateway.

8. The smart identifying apparatus of claim 1, wherein the processing circuit controls the communicating circuit to continuously attempt to communicate with the IOT gateway in a proofing mode, no matter what user motion is detected; and
wherein the processing circuit further compares the user motion detected by the motion detecting circuit with a result that the communicating circuit attempts to communicate the IOT gateway, to set the predetermined motion rule.

9. The smart identifying apparatus of claim 1, wherein the processing circuit adjusts the predetermined motion rule according to a communicating result that the communicating circuit attempts to communicate with the IOT gateway if the predetermined motion rule is matched.

10. The smart identifying apparatus of claim 1, wherein the motion detecting circuit is an accelerometer.

11. The smart identifying apparatus of claim 1, wherein the motion detecting circuit is a vibration sensor, which generates a corresponding signal to the processing circuit if a vibration is detected.

12. The smart identifying apparatus of claim 1, wherein the processing circuit activates a predetermined operation corresponding to a location for an outside server, if the communicating circuit successively communicates with the IOT gateway.

13. The smart identifying apparatus of claim 1, wherein the wireless communication protocol is a Z-wave protocol.

14. The smart identifying apparatus of claim 1, further comprising a switching apparatus, configured to activate or to stop an operation that the communicating circuit is controlled to attempt to communicate with the IOT gateway according to an motion detected by the motion detecting circuit.

15. The smart identifying apparatus of claim 1, wherein the processing circuit further has a security mode, in which the smart identifying apparatus is provided in an object to be protected, wherein the communicating circuit informs the IOT gateway to activate a corresponding security operation if the processing circuit is in the security mode and the motion detecting detects an motion.

16. The smart identifying apparatus of claim 1, wherein the processing circuit controls the communicating circuit to periodically attempt to communicate with the IOT gateway after a predetermined time according to the predetermined motion rule, if no motion is detected.

17. The smart identifying apparatus of claim 1, further comprises a time circuit, wherein the processing circuit applies different motion rules according to a current time provided by the time circuit.

18. The smart identifying apparatus of claim 1, wherein the processing circuit collects statistical data and gets a percentage that the communicating circuit successfully connect to the IOT gateway at different timings, to adjust the predetermined motion rule.

19. The smart identifying apparatus of claim 1, further comprising an additional communicating circuit configured to determine a location for the smart identifying apparatus via an additional communicating protocol, wherein the control circuit attempts to communicate with the IOT gateway according to the additional communicating circuit.

20. The smart identifying apparatus of claim 1, further comprising a battery circuit, wherein if the battery detects that a power is lower than a predetermined value, the processing circuit sets a rule that the communicating circuit attempt to communicate with the IOT gate wat according to the power
